(19) United States
(12) Patent Application Publication
(10) Pub. No.: US 2008/0075144 A1
(43) Pub. Date: Mar. 27, 2008

(54) Display assembly of a digital thermometer

(76) Inventor: Chao-Man Tseng, Taichung (TW)

Correspondence Address: Chao-Man Tseng, 235 Chung-Ho, Box 8-24, Taipei, omitted

(21) Appl. No.: 11/526,912

(22) Filed: Sep. 26, 2006

(51) Int. Cl. G01K 7/00

(52) U.S. Cl. 374/170

(57) ABSTRACT

A display assembly of a digital thermometer comprises: a heat sensor, a display unit, a backlight plate, and a processor; wherein the heat sensor measures temperature; after measurement of temperature, if it is detected that the temperature is decreased, the processor will actuate the backlight plate for illuminating the display unit. The display unit displays measured temperature values after measurement of temperature. The display unit is actuated with the backlight plate for displaying the measuring data. A buzzer is installed in the thermometer, after measurement of temperature, the buzzer will emit sound. The processor can de-actuate automatically. The thermometer has an adjustment unit.

### FIELD OF THE INVENTION

The present invention relates to thermometers, and particularly to a display assembly of a digital thermometer, wherein the actuation of backlight plate is designed to reduce the power lose so as to prolong the lifetime of the thermometer.

### BACKGROUND OF THE INVENTION

In some kind of prior art thermometer, a backlight plate is installed at a backside of a display unit. When the temperature is measured, the backlight plate will light up to illuminate the display unit so that the user can view the temperature. When the measurement of temperature is complete, the backlight plate will light up automatically. However, the period after measurement of temperature and before taking out the thermometer will induce the undesired power waste due to the power lose from the backlight plate.

Moreover, generally, the power source of a thermometer is installed in the thermometer. It is difficult to take out. The power lose from the backlight plate will cause a great power reduction in the power source and thus the panel of the display unit will become dim. Furthermore the lifetime of the thermometer will short.

### SUMMARY OF THE INVENTION

Accordingly, the primary object of the present invention is to provide a display assembly of a digital thermometer, wherein the actuation of backlight plate is designed to reduce the power loss so as to prolong the lifetime of the thermometer.

To achieve above objects, the present invention provides a display assembly of a digital thermometer which comprises: a heat sensor, a display unit, a backlight plate, and a processor; wherein the heat sensor measures temperature; after measurement of temperature, if it is detected that the temperature is decreased, the processor will actuate the backlight plate for illuminating the display unit. The display unit displays measured temperature values after measurement of temperature. The display unit is actuated with the backlight plate for displaying the measuring data. A buzzer is installed in the thermometer, after measurement of temperature, the buzzer will emit sound. The processor can de-actuate automatically. The thermometer has an adjustment unit.

The various objects and advantages of the present invention will be more readily understood from the following detailed description when read in conjunction with the appended drawing.

### BRIEF DESCRIPTION OF THE DRAWINGS

FIG. 1 is a schematic perspective view of the display assembly of a digital thermometer of the present invention.

FIG. 2 is a block diagram about the elements of the display assembly of a digital thermometer of the present invention.

FIG. 3 is a schematic view showing the use of the display assembly of a digital thermometer of the present invention.

FIGS. 4 and 5 are schematic view showing the application about the backlight plate of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

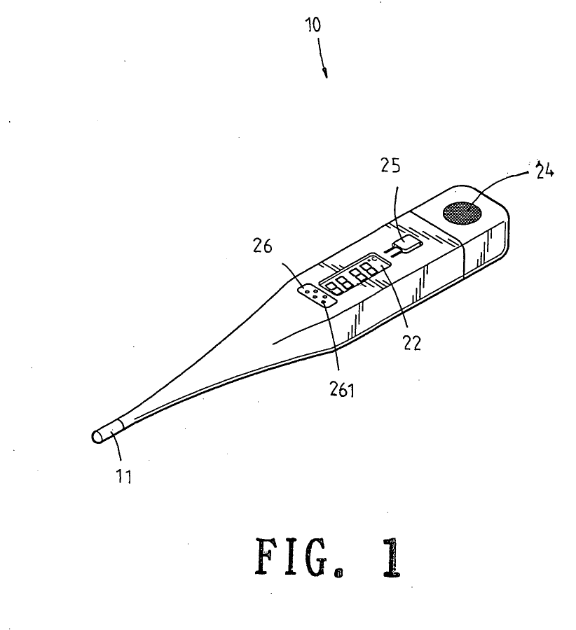

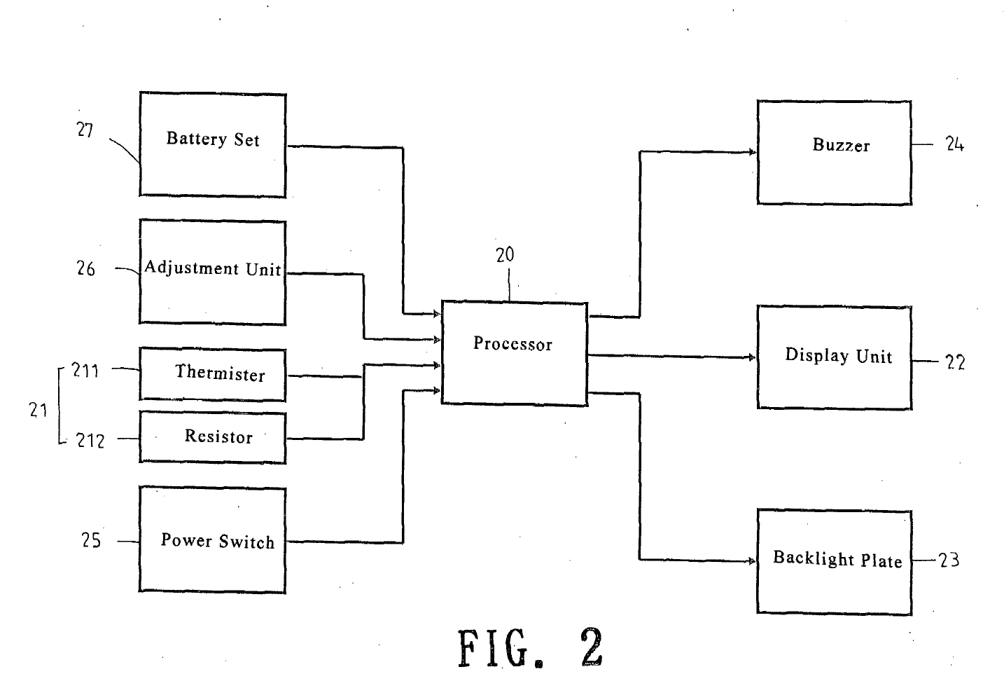

Referring to FIGS. 1 and 2, the digital thermometer display assembly of the present invention is illustrated. The thermometer 10 of the present invention has the following elements.

A processor 20 serves for integrating signals of different elements and for setting the operation.

A heat sensor 21 includes a thermister 211 and a resistor 212. The thermister 211 is installed at a measuring end 11 at a front end of the thermometer 10. The thermister 211 is located to be near an object so as to achieve heat equilibrium for a predetermined time period. When temperature changes, the resistor of the thermister 211 will change. The variation of the thermister 211 is compared with a resistor 212 having a fixed resistance in the processor so as to get the body temperature of the user. In the present invention, the thermister 211 can be replaced by other thermal sensor.

A display unit 22 may be a liquid crystal display. The display unit 22 exposes out of the surface of the thermometer 10 for receiving the signal from the processor 20 and displaying the value of temperature digitally. The display unit 22 is installed at one side of the thermometer 10 so that the user can view the value of the display unit 22.

A backlight plate 23 is installed in the thermometer 10 and at a lower side of the display unit 22. The backlight plate 23 is controlled by the processor 20 so that the backlight plate 23 can be actuated for illuminating the display unit 22. Thereby the user can view the display data.

A buzzer 24 is installed at one end of the thermometer 10. The buzzer 24 is controlled by the processor 20. After measuring the temperature, buzz sounds are emitted for alerting the user.

A power switch 25 is at an outer side of the thermometer 10. The power switch 25 serves to open or close the thermometer 10.

An adjustment unit 26 has a plurality of control buttons 261 for setting and calibration.

A battery set 27 serves to supply power to the system.

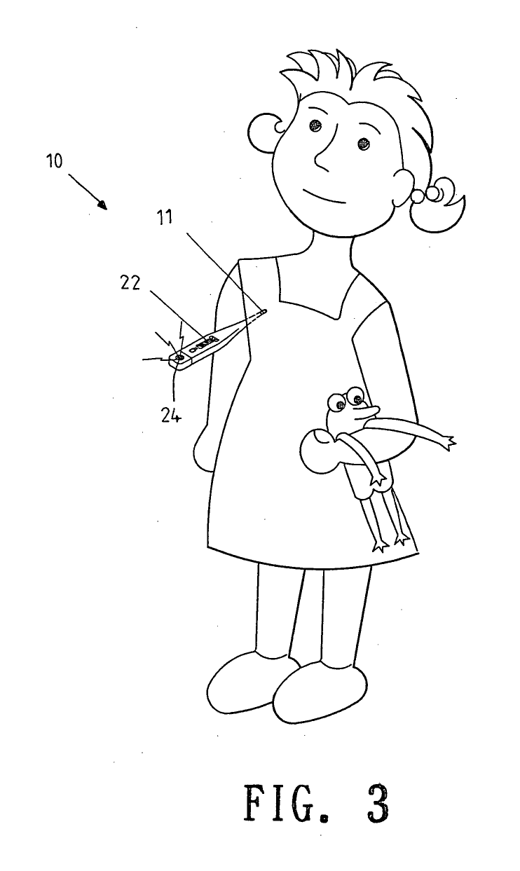

In use of the present invention, referring to FIGS. 3 to 5, firstly, the power switch 25 is pressed to actuate a power source. Then the measuring end 11 of the thermometer 10 is clamped in a place for measuring data. The thermister 211 of the heat sensor 21 is placed on the object to be measured to achieve heat equilibrium.

Then the heat equilibrium state is retained through a time period. After complete the measurement, the processor 20 compares the value from the thermister 211 and resistor 212 to get the temperature, as shown in FIG. 3, the buzzer 24 emits buzz sounds to alert the user that the measurement is complete. The processor 20 displays the measuring data through the display unit 22.

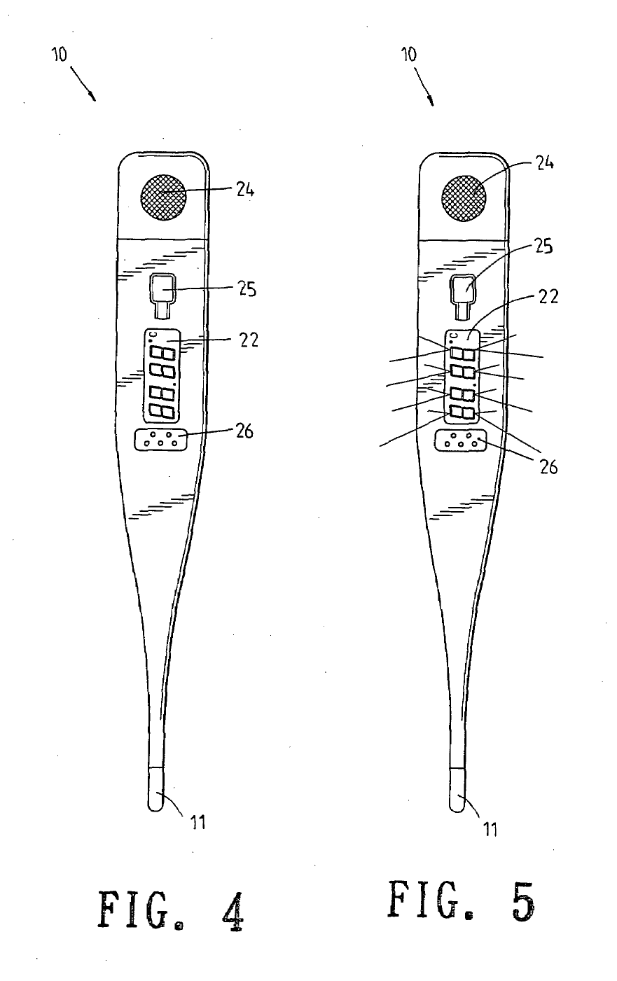

When the thermometer 10 is not taken out from the object to be measured, the thermometer 10 in the measurement end is retained in heat equilibrium with the object. The backlight plate 23 will not actuate, as shown in FIG. 4. If the user take out the thermometer 10 from the object. The measuring end 11 will contact with external environment. The processor 20 can sense temperature variation through the thermister 211. Then the processor 20 actuates the backlight plate 23 to illuminate the display unit 22, as shown in FIG. 5.

The display unit 22 can display temperature values after temperature measurement by the setting of the adjustment unit 26, or the data is displayed once the backlight plate 23 is actuated or when user need view the display unit 22, the processor 20 will actuate the display unit 22 for power saving.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A display assembly of a digital thermometer comprising: a heat sensor, a display unit, a backlight plate, and a processor;
wherein the heat sensor measures temperature; after measurement of temperature, if it is detected that the temperature is decreased, the processor will actuate the backlight plate for illuminating the display unit.

2. The display assembly of a digital thermometer as claimed in claim 1, wherein the display unit displays measured temperature values after measurement of temperature.

3. The display assembly of a digital thermometer as claimed in claim 1, wherein the display unit is actuated with the backlight plate for displaying the measuring data.

4. The display assembly of a digital thermometer as claimed in claim 1, wherein a buzzer is installed in the thermometer, after measurement of temperature, the buzzer will emit sound.

5. The display assembly of a digital thermometer as claimed in claim 1, wherein the processor can de-actuate automatically.

6. The display assembly of a digital thermometer as claimed in claim 1, wherein the thermometer has an adjustment unit.
